(19) United States
(12) Patent Application Publication
(10) Pub. No.: US 2026/0307951 A1
(43) Pub. Date: Oct. 8, 2026

(54) CABIN OF A VEHICLE CRANE COMPRISING A SWING DOOR

(71) Applicant: TADANO FAUN GmbH, Lauf an der Pegnitz (DE)

(72) Inventors: Matthias Appold, Ottensoos (DE); Olaf Remmers, Wilhelmshaven (DE)

(21) Appl. No.: 19/638,848

(22) Filed: Apr. 3, 2026

(30) Foreign Application Priority Data
Apr. 4, 2025 (DE) 102025113433.2

(51) Int. Cl. B66C 13/54

(52) U.S. Cl. CPC B66C 13/54

(57) ABSTRACT

A cabin of a vehicle crane includes a swing door fastened to the cabin via a lower door mechanism and an upper door mechanism, the swing door being movable between closed and open positions. The lower door mechanism may be designed in the form of a parallelogram. To provide a cabin of a work machine, in particular a vehicle crane, with an optimised swing door, the movement of the swing door can be locked, by means of a locking brake, between the closed position and the open position. The locking brake optionally acts on the lower door mechanism.

### FIELD

The present application relates to swing door for a cabin of a vehicle crane.

### BACKGROUND

German laid-open document DE 103 61 831 A1 discloses a cabin having a single-leaf swing door for use on a crane or excavator. This swing door can be used to close and open a door opening arranged on the side of the cabin. To this end, the swing door is suspended on the inside at its upper end via a support joint with a vertical pivot axis in the upper region of the door opening. This support joint is intended to support the weight of the swing door and is fastened to a bent support arm which terminates with its opposite end at a vertical rotating rod. The rotating rod is mounted so as to be able to rotate at the top and bottom of the cabin on the inside next to a longitudinal side of the door opening. In order to open and close the swing door, the rotating rod is driven about its longitudinal axis in the direction of rotation. In addition, the swing door is connected to the cabin at the top via a further guide lever and at the bottom via two further guide levers. Via the total of three guide levers and the support arm, the swing door can then be moved in a stable manner over a defined movement path into and out of the door opening. The swing door is moved as a whole in the manner of a parallelogram via the guide levers and the support arm. In this case, the section of the movement path during the immediate closing and opening of the door opening by means of the swing door is almost linear, whereby rubber seals provided in the swing door and the door opening are subjected to stress only in the sealing direction and are not deformed by any lateral forces.

Furthermore, European patent specification EP 1 085 154 B1 discloses a sliding door for a cabin of a construction machine, in particular a hydraulic excavator or a vehicle crane. The sliding door is guided at the top and bottom via rollers in guide rails on the cabin. In order to open and close the sliding door or a door opening of the cabin, the guide rails are each formed in an arcuate manner at one end.

The subsequently published, German laid-open document DE 10 2023 131 660 A1 discloses a cabin of a mobile crane having a driven swing door. This swing door is fastened to the cabin via a first lower rocker arm and a second upper rocker arm. Via a drive which acts on the second upper rocker arm, the swing door can be moved from a closed position into an open position, and vice-versa. The swing door can also be secured in a continuously variable manner between the closed position and the open position via a latching or braking mechanism.

Furthermore, U.S. patent application Pub. No. 2020/0181966 discloses a wheel loader cabin having a revolving door which can be held in all intermediate positions. The revolving door is driven via an electric motor which cooperates with a self-locking worm gear for stopping the revolving door.

### SUMMARY

The present application is directed to a swing door for a cabin of work machine such as a vehicle crane, in which the swing door which is fastened to the cabin via a lower door mechanism and an upper door mechanism, and is movable between closed and open positions. The lower door mechanism may be designed in the form of a parallelogram, where optimisation of the swing door may be achieved movement of the swing door between the closed position and the opening position in a manner so that it can be locked by means of a locking brake that acts on the lower door mechanism, for example. In this manner, the crane operator can set any open position of the swing door in order to ventilate the cabin and for the purpose of external communication. Even if the cabin is inclined to a tilted working position, unintended opening of the swing door by inclination of the cabin can be prevented by means of the locking brake. Optionally, the locking brake acts on the lower door mechanism and is thus arranged on the floor of the cabin, without impairing the view of the crane operator. Moreover, the upper door mechanism is kept free of other components which could impair the crane operator's view upwards.

In one particular embodiment, provision is made that the locking brake operates electrically and/or in a continuously variable manner.

In another embodiment, the locking brake can be actuated electrically and includes a brake disc and brake shoes.

Advantages for the operation and safety of the swing door are apparent from the fact that the locking force of the locking brake can be set such that the swing door can be securely held in any position between the closed position and the open position and including the closed position and the open position, but nevertheless emergency opening in any position is possible.

Optionally, the swing door is movable between the closed position and the open position manually by the crane operator and not in a manner driven by motor.

In another embodiment, the upper door mechanism has a single upper guide lever which is fastened via a first upper guide joint to the swing door and is fastened via a second upper guide joint to the cabin. This means that the roof of the cabin can be configured to be transparent to the greatest possible extent without the upper door mechanism obstructing the crane operator's view through the roof of the cabin. The cabin in accordance with the invention is characterised by robustness with a high level of ease of operation during opening and closing. The swing door per se is optimum for accessing and entering a cabin.

In a further embodiment, the lower door mechanism has a first support lever and a second support lever, wherein the first support lever is fastened via a first lower support joint to the swing door and is fastened via a third lower support joint to the cabin, and the second support lever is fastened via a second lower support joint to the swing door and is fastened via a fourth lower support joint to the cabin. The lower door mechanism is designed to be stable and supports the majority of the weight of the swing door and so the upper door mechanism can consist of a single upper guide lever. Overall, the swing door is thus suspended at only three points. This suspension is inherently rigid. Moreover, the suspension does not require the arrangement of guide rails on the cabin, which is simple in structural terms.

The movement speed of the swing door is limited by virtue of the fact that a gas spring is allocated to the lower door mechanism. The gas spring facilitates the opening of the swing door up to the dead centre of the gas spring and ensures that the swing door opens further as far as the end stop in the open position. In order to close the door from the end stop from the open position as far as the dead centre of the gas spring, the gas spring provides assistance again and ensures that the swing door closes easily after the dead centre of the gas spring.

In still another embodiment, provision is made that the gas spring is arranged in an articulated manner between the first support lever or the second support lever and a floor of the cabin. In an alternative embodiment, provision could be made that two gas springs are attached to both support levers.

In yet another embodiment, a supporting tube is arranged between the first lower support joint and the first upper support joint. In this case, the supporting tube is allocated to the swing door and therefore also moves with the swing door outwards and does not decrease the size of the inner space and/or the door opening of the cabin.

The operation of the swing door is optimised by virtue of the fact that a damper is allocated to the lower door mechanism and dampens the movement of the swing door in the region of the open position. This damper operates as an end stop and prevents the swing door from striking against a side surface of the cabin.

By virtue of the fact that the cabin can be inclined upwards and downwards relative to the work machine about a horizontal pivot axis, the crane operator can adapt their work field of vision with respect to the horizontal orientation to suit the situation.

In the context of the present invention, the term “vehicle crane” is understood to mean either a mobile crane or a telescopic crane having a lower carriage which has rubber tyres and can travel on public roads, or a crawler crane having a lattice mast jib. Owing to its robust design and the optimised movement path during opening and closing, the swing door in accordance with the invention and described above is particularly suitable for cabins having variable inclination angles.

Further details of the present disclosure will be apparent from the following description of exemplified embodiments by reference to the drawings.

### BRIEF DESCRIPTION OF THE DRAWINGS

FIG. 1 shows a schematic illustration of a vehicle crane having a telescopic jib;

FIG. 2 shows a perspective view of a cabin with a closed swing door;

FIG. 3 shows a side view of an upwardly inclined cabin;

FIG. 4 shows a further perspective view of the cabin with a closed swing door and an associated door mechanism;

FIG. 5 shows a plan view of a floor of the cabin with a lower door mechanism;

FIG. 6 shows a perspective view of an upper door mechanism; and

FIG. 7 shows a perspective view of a lower region of the swing door.

### DETAILED DESCRIPTION

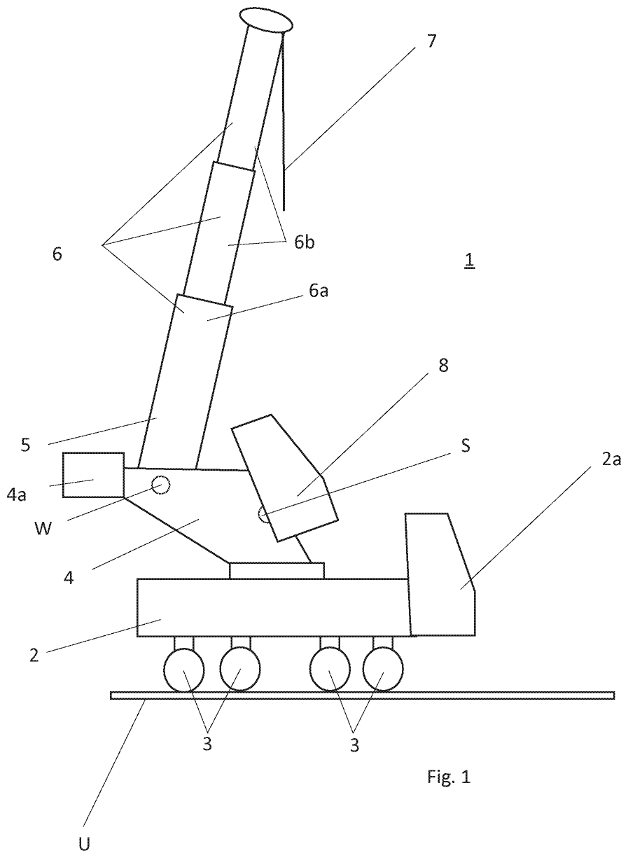

FIG. 1 shows a schematic view of a vehicle crane 1, in particular a mobile crane, from one side, which is parked on a horizontal ground surface U. The vehicle crane 1 which can travel on public roads has a multi-axle lower carriage 2 having wheels 3 fitted with pneumatic tyres. Arranged on the lower carriage 2 is a superstructure 4 which can be pivoted about a vertical axis relative to the lower carriage 2. A telescopic jib 5 is mounted on the superstructure 4 so as to be luffable about a horizontal axis, and a counterweight 4a is mounted at its rear end. The telescopic jib 5 typically consists of a large number of jib parts 6, in particular an outer basic box 6a which accommodates a plurality of inner boxes 6b of the telescopic jib 5 which can be extended and retracted telescopically. In a retracted state, the inner boxes 6b rest almost completely in the basic box 6a. The basic box 6a is articulated in a luffable manner on the superstructure 4 in order to be able to luff the telescopic jib 5 up and down. A hoisting cable 7 extends over a free end of the telescopic jib 5, in particular its innermost inner box 6b, from which cable a load picking-up means, not illustrated, such as e.g. a load hook or a lower block for reeving cable with a load hook is suspended. It can be seen that the lower carriage 2 has, at a front end, a driver's cabin 2a for a driver, in particular for when the vehicle crane 1 is travelling on roads and also across country.

In addition, FIG. 1 shows that a further cabin 8 for a crane operator is arranged at a front end of the superstructure 4. This cabin 8 is fastened to the superstructure 4 so as to be able to be inclined via a pivot axis S. In this case, the pivot axis S is oriented horizontally and transversely with respect to the superstructure 4 and extends in parallel with a luffing axis W, via which the telescopic jib 5 is mounted on the superstructure 4. Moreover, as seen in a vertical direction, the pivot axis S is arranged approximately in the centre and on a rear side of the cabin 8. The fact that the cabin 8 can be inclined upwards and downwards makes it easier for the crane operator, particularly from an ergonomic point of view, to observe the telescopic jib 5 and any load suspended from the telescopic jib 5 during operation of the vehicle crane 1. The crane operator's work field of vision can thus be adapted to suit the situation.

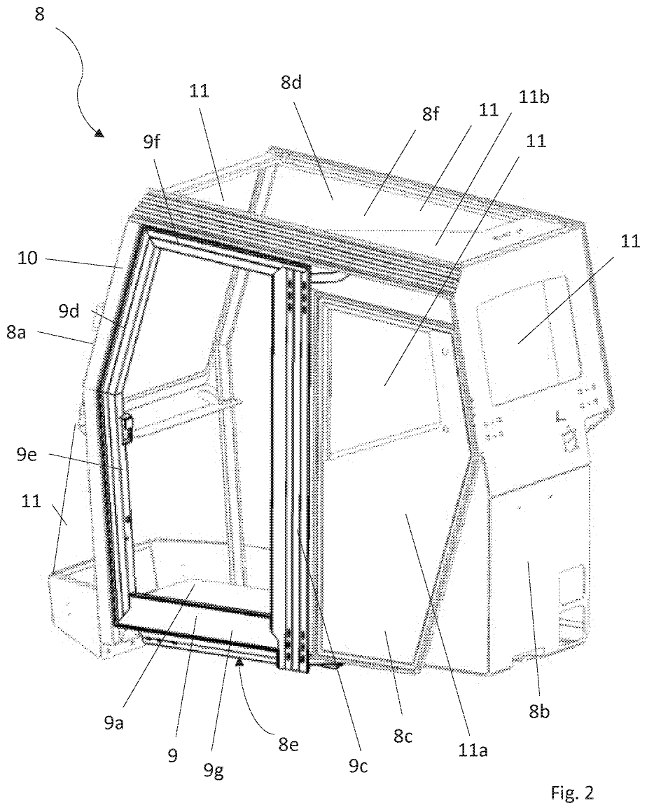

FIG. 2 shows a perspective view of a cabin 8 having a swing door 9 which, in a closed position, closes off a door opening 10 in the cabin 8. For improved clarity, the cabin 8 is shown without the superstructure 4 and without installation elements, such as e.g. a seat with control elements. Naturally, the door opening 10 is almost completely concealed by the swing door 9. The cabin 8 has overall the shape of a narrow, upright cuboid, wherein a length—as seen in the longitudinal direction of the superstructure 4—and a height of the cabin 8 are approximately equal, and the width of the cabin 8 provides sufficient space for a seat, not illustrated, with control elements for the crane operator. The width of the cabin 8 corresponds approximately to half the height or length of the cabin 8. Corresponding to the cuboidal shape of the cabin 8, it has a front surface 8a, a rear surface 8b, a left side surface 8c, a right-side surface 8d, a floor 8e and a roof 8f. In this case, the front surface 8a is directed forwards in relation to the superstructure 4, i.e. it is arranged at the opposite end of the superstructure 4 in relation to the counterweight 4a of the superstructure 4. With the exception of the floor 8e, the front surface 8a, the rear surface 8b, the left side surface 8c, the right-side surface 8d, the floor 8e and the roof 8f are each provided, in the manner of a window, with an at least partially transparent pane 11, and the swing door 9 is provided with an at least partially transparent door pane 9a.

It is also apparent from FIG. 2 that the flat roof 8f with the pane 11 at the front is inclined from the front surface 8a rearwards to the rear surface 8b downwards in relation to the floor 8e by an inclination angle in the range of 5 to 20°. This improves a wedge angle of visibility of the cabin 8 for the crane operator at any inclination because an upper horizontal cross profile 8g between the two front A-pillars of the cabin 8 as a contour disrupting the crane operator's wedge angle of visibility is displaced upwards, thereby improving the overall wedge angle of visibility for tracking loads as compared to other cabins. Moreover, rainwater will run off the roof 8f more easily and will not drip at the front into the cabin 8 when the front pane is open. Any rainwater can therefore run off the roof 8f more easily. In a basic position of a non-inclined cabin 8, the floor 8e is horizontally oriented. Furthermore, the front half of the cabin 8 consists substantially, i.e. more than 80%, only of panes 11 and the door pane 9a, in order to make the crane operator's work easier, as described above. All panes 11 are tinted and additionally have shades on the inside, provided in particular by roller blinds.

FIG. 2 illustrates the swing door 9 in its closed position. In order to open the swing door 9, it is initially moved almost linearly outwards from the closed position in the door opening 10 via a door mechanism described later, and is then moved rearwards along the left side surface 8c on an evenly arcuate path and so, in an open position, the door opening 10 is almost completely, i.e. more than 90%, open.

Overall, the swing door 9 is designed as a frame having a door pane 9a. The swing door 9 is substantially rectangular with an angular bulge to the front, and the angular frame consists of a rear frame 9c, first and second front frames 9d, 9e forming an obtuse angle, an upper frame 9f and a lower frame 9g. This frame design is robust and designed to be resistant to twisting, ensuring that the swing door 9 opens and closes smoothly even when the cabin 8 is inclined. Moreover, the frame design consisting of profiles made by continuous casting allows for the integration of design elements and additional functional elements. The cabin 8 is also constructed as a frame consisting of profiles made by continuous casting.

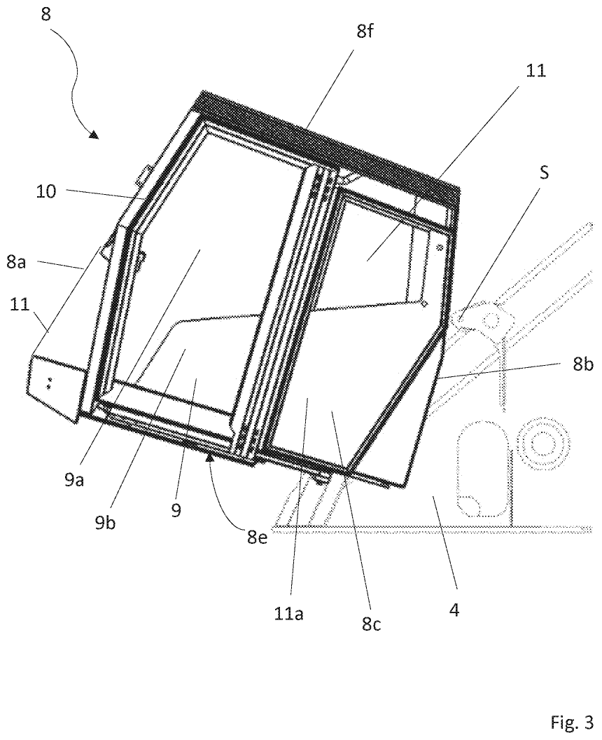

FIG. 3 shows a side view of an upwardly inclined cabin 8, with the swing door 9 in its closed position. The cabin 8 is inclined upwards about the pivot axis S by approximately 15° from a horizontal position. The continuously variable pivot range of the cabin 8 is 0 to 30°. It is also apparent that, in the left side surface and in the right, not shown, side surface 8c, 8d, the door pane 9a and the pane 11 in a lower region 9b, 11a are, for aesthetic reasons, not completely transparent, but may be opaque and have a black backing. This does not impair the crane operator's circumferential visibility. The same applies to the roof 8f and has already been illustrated in FIG. 2.

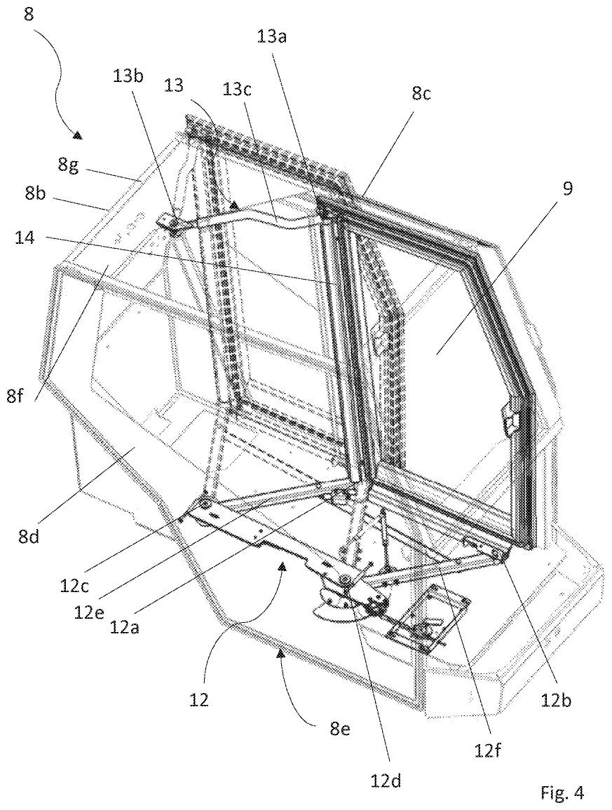

FIG. 4 illustrates a further partially transparent, perspective view of the right-side surface 8d of the cabin 8 in order to show the closed swing door 9 from the inside and an associated lower and upper door mechanism 12, 13 in the floor 8e. For this purpose, the floor 8e is constructed as a cavity floor with an inner upper floor surface facing the crane operator, and a lower outer floor surface forming the outer skin of the cabin 8. The lower door mechanism 12 is arranged in this cavity. Moreover, the swing door 9 is additionally illustrated in hatched form in its open position moved rearwards and lying almost against the left side surface 8c.

As seen from above towards the floor 8e, the lower door mechanism 12 has a substantially parallelogram-shaped structure
having a first lower support joint 12a which is arranged at the rear lower end of the swing door 9 and is a swivel joint with a vertical axis of rotation,
having a second lower support joint 12b which is arranged at the front lower end of the swing door 9 and is also a swivel joint with a vertical axis of rotation,
having a third lower support joint 12c which is arranged in the floor 8e and in an offset manner inwards and rearwards in relation to the first lower support joint 12a and is also a swivel joint with a vertical axis of rotation,
having a fourth lower support joint 12d which is arranged in the floor 8e and in an offset manner inwards and rearwards in relation to the second lower support joint 12b and is also a swivel joint with a vertical axis of rotation,
having a first support lever 12e which is arranged in an articulated manner between the first lower support joint 12a and the third lower support joint 12c and
having a second support lever 12f which is arranged in an articulated manner between the second lower support joint 12b and the fourth lower support joint 12d.

The first and second support levers 12e, 12f are arranged in a common horizontal plane. The lower door mechanism 12 is dimensioned such that it supports substantially the entire weight of the swing door 9.

Between the open position and the closed position, the first and second support levers 12e, 12f move by approximately 70 to 75° about their respective lower third and fourth support joints 12c, 12d.

The upper door mechanism 13 deviates from the structure of the lower door mechanism 12, since this primarily has a guiding function rather than a supporting function. The upper door mechanism 13 has a very simple structure
having a first upper guide joint 13a which is arranged at the rear upper end of the swing door 9 and is a swivel joint with a vertical axis of rotation,
having a second upper guide joint 13b which is arranged on the roof 8f and in an offset manner inwards and rearwards in relation to the first upper guide joint 13a, and is a ball joint with a vertical axis of rotation and
having an upper guide lever 13c which is arranged in an articulated manner between the first upper guide joint 13a and the second upper guide joint 13b.

The first upper guide joint 13a and the first lower support joint 12a are arranged one above the other as seen in the vertical direction, and their vertical axes of rotation are aligned with one another. Furthermore, the first upper guide joint 13a and the first lower support joint 12a are connected to one another via a supporting tube 14, whereby the lower and upper door mechanisms 12, 13 are stabilised with respect to one another. The supporting tube 14 extends in parallel and at small spaced interval with respect to a rear frame 9c of the swing door 9 and is fastened only to the first upper guide joint 13a and the first lower support joint 12a. The supporting tube 14 is not, as in other door mechanisms, mounted at the top on the roof 8f and at the bottom on the floor 8e. Unlike the lower door mechanism 12, the upper door mechanism 13 does not have a third and fourth upper guide joint, nor does it have a second guide lever. The upper guide lever 13c has the task of guiding the swing door 9 and, when the swing door 9 is in the closed position, of holding the swing door 9 in the closed position via the arrangement of the second upper guide joint 13c, which is displaced rearwards on the roof 8f, i.e. of pressing against the swing door 9 in the door opening 10.

Overall, it is evident that the swing door 9 is held and guided via the first and second lower support joints 12a, 12b and the first upper guide joint 13a and thus at three points in total. Moreover, it may be advantageous to transfer the supporting function to the lower door mechanism 12 and to position it on the floor 8e because this allows the upper door mechanism 13 to be designed in a structurally simple manner and thus it does not obstruct the crane operator's circumferential visibility. The lower door mechanism 12 is then covered from above by means of an intermediate floor. Also, the crane operator's view upwards is not obstructed by the upper door mechanism 13 because the single second upper guide joint 13b is arranged on the roof 8f in an offset manner inwards and extensively rearwards in relation to the first upper guide joint 13a. In relation to the length of the roof 8f, the second upper guide joint 13b is arranged in the rear third of the roof 8f. The pane 11 of the roof 8f is therefore not transparent only in a small rear region 11b.

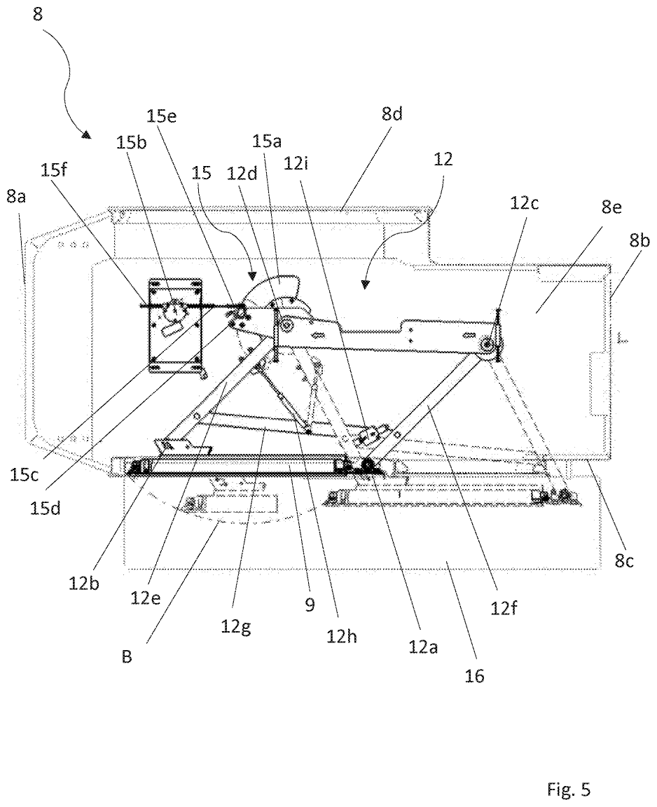

FIG. 5 shows a plan view of the floor 8e of the cabin 8 with the lower door mechanism 12, explained by reference to the further details of the lower door mechanism 12. In this case also, the swing door 9 is additionally moved, as shown in a dotted illustration, in its open position rearwards and is illustrated lying almost against the left side surface 8c. An elongate, strip-shaped connector 12g is arranged between the first support lever 12e and the second support lever 12f via likewise vertical axes of rotation. On the one hand, the connector 12g stabilises the parallelogram and serves on the other hand as a fastening base for a gas spring 12h which is supported at one end on the second support lever 12f in the region of the fourth lower support joint 12d and is supported at its other end in the region of the first lower support joint 12a on the floor 8e. Alternatively, the gas spring 12h can be provided on the first support lever 12e, or two gas springs 12h can be provided in each case on one of the two support levers 12e, 12f. A gas spring 12h thus dampens overall the movement during opening and closing and thus facilitates the manual opening and closing of the swing door 9. A damper 12i which serves as an end stop for the swing door 9 in the open position is arranged between the floor 8e and the end of the first support lever 12e close to the swing door.

In addition, a locking brake 15 is provided which allows the swing door 9 to be fixed in any position in a continuously variable manner between the closed position and open position. For this purpose, a segment of a brake disk 15a is arranged in the region of the first lower support joint 12a in a concentric manner with respect to the first lower support joint 12a. The brake disk 15a can be fixed in a continuously variable manner via a drive 15b and brake shoes 15d. This type of locking brake 15 is low-wear. The brake is actuated via the drive 15b which is an electric motor having a worm gear, and via a linkage 15c driven linearly by the worm gear, acts on the brake shoes 15d via a lever attached at this location. The linkage 15c actuates the brake shoes 15d by pulling. The locking brake 15 allows the crane operator to adjust the swing door 9 to any open position in order to ventilate the cabin 8 or for the purpose of external communication, even if the cabin 8 is inclined to a tilted working position. The swing door 9 is also held securely in the closed position and open position. The locking brake 15 can prevent the swing door 9 from being opened unintentionally by virtue of the cabin 8 being inclined. Provision can be made that the force of the locking action is adjustable via a spring 15e between the linkage 15c and the brake shoes 15d and is selected such that the swing door 9 is fixed in any tilt position of the cabin 8, whilst still allowing for emergency opening, particularly from the outside, in any position. The locking force of the locking brake 15 can be adjusted via an adjusting screw 15f on the linkage 15c. In principle, it is also feasible to design the locking brake 15 as a mechanical device.

The design of the parallelogram of the lower door mechanism 12 includes the two support levers 12e, 12f, their respective length, the arrangement of the third lower support joint 12c and the fourth lower support joint 12d with respect to the swing door 9 is optimised such that the swing door 9 swings as little as possible out of the contour of the cabin 8-as seen in plan view. This ensures that the ease of access to a platform in front of the left side surface 8c or the door opening 10 is restricted to the least possible extent. In the open position, the swing door 9 lies almost against the left side surface 8c. FIG. 5 also shows that, during opening and closing, the front end of the swing door 9 moves along a movement path B which is circular and flat, and so the swing door 9 protrudes from the door opening 10 by a maximum of three times its thickness during opening or closing. This leaves sufficient space for the crane operator to stand comfortably on the platform 16 whilst opening and closing the swing door 9. In the open position, the maximum distance between the swing door 9 and the left side surface 8c is approximately only one and a half times its thickness.

By adjustably mounting the entire lower door mechanism 12 relative to the floor 8e, the swing door 9 can be adjusted inwards and outwards, as well as forwards and backwards, in relation to the door opening 10.

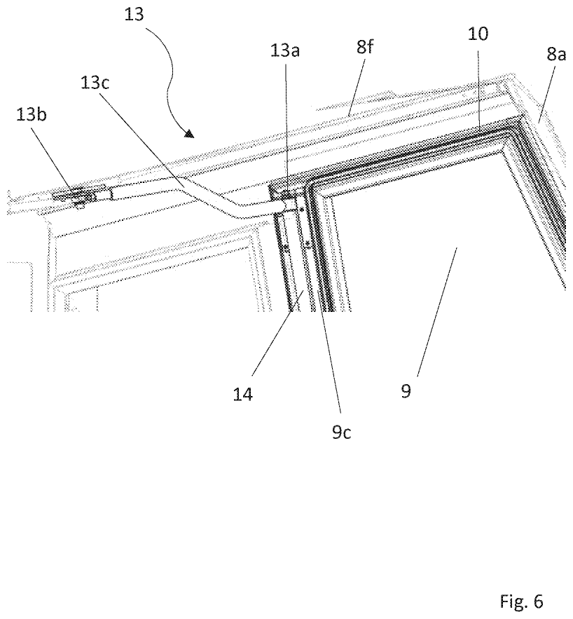

FIG. 6 shows a perspective view of an upper door mechanism 13. It is evident that the first upper guide joint 13a is arranged on the rear frame 9c of the swing door 9 such that it can be adjusted in the vertical direction via elongate holes. The same applies to the lower first support joint 12a. The supporting tube 14 directly adjoins the first support joint 12a. Via the mounting of the second upper guide joint 13b, which is a ball joint with a vertical axis of rotation, on the roof 8f, the swing door 9 can be adjusted inwards and outwards, as well as forwards and backwards, in relation to the door opening 10.

The adjustment options for the swing door 9 with respect to the door opening 10 in the cabin 8 ensure that the swing door 9 lies in a planar manner against the door opening 10 via its seal. This results in reduced wear on the seals and in a reliable seal. The robustness of the swing door 9 by virtue of its design as a frame means that the swing door 9 ensures there is less displacement with respect to the door opening 10 during operation. Nevertheless, specific maintenance intervals are required. Reorientation of the swing door 9 with the door opening 10 is simple and possible with a clear concept due to the previously described adjustment options in the region of the lower and upper door mechanisms 12, 13. These adjustment options also serve to compensate for manufacturing tolerances during the initial adjustment of the swing door 9 with respect to the door opening 10.

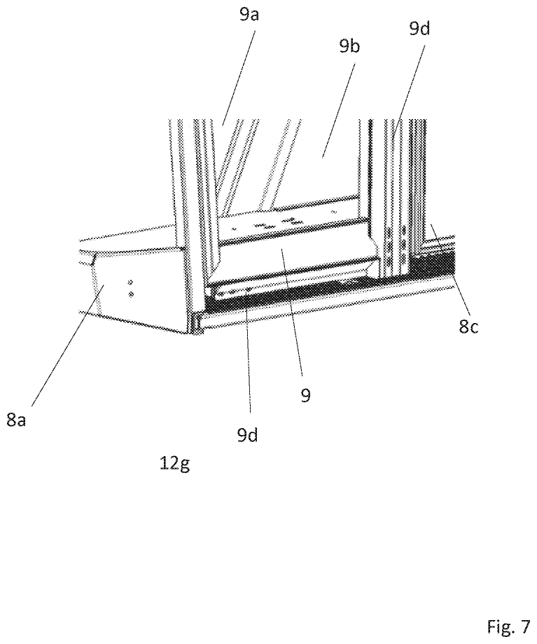

FIG. 7 shows a perspective view of a lower region of the swing door 9. At the bottom end, the swing door 9 has a recess 9d across its entire width as seen from the outside, providing the crane operator with more foot space. This improves stability on the platform 16, which has a positive influence on safety at work.

In connection with the present exemplified embodiment, the cabin 8 having the swing door 9 has been described as a component of a vehicle crane 1. In principle, it is also feasible for this cabin 8 having the swing door 9 in accordance with the invention to also be used in mobile work machines, in particular construction machines, such as excavators. It is also feasible for the driver's cabin 2a of the vehicle crane 1 to be equipped with the swing door 9 in accordance with the invention. Also, the terms “horizontal” and “vertical” selected in the above description of the exemplified embodiment refer in each case to a horizontally oriented cabin 8 and a horizontally oriented floor 8e. Furthermore, it is feasible for the lower door mechanism 12 to be designed to be electrically driven. For this purpose, provision is made that an electric motor engages with the third lower support joint 12c.

Changes and modifications in the specifically described embodiments can be carried out without departing from the principles of the present invention which is intended to be limited only by the scope of the appended claims, as interpreted according to the 10 principles of patent law including the doctrine of equivalents.

1. A cabin of a vehicle crane, the cabin comprising:
a lower door mechanism designed in the form of a parallelogram;
an upper door mechanism;
a swing door fastened to the cabin via the lower door mechanism and the upper door mechanism, wherein the swing door is movable between closed and open positions; and
a locking brake configured to act on the lower door mechanism to selectively lock the swing door between the closed and open positions can be selectively locked.

2. The cabin of claim 1, wherein the locking brake operates electrically and/or in a continuously variable manner.

3. The cabin of claim 1, wherein the locking brake comprises a brake disc and brake shoes, and can be actuated electrically.

4. The cabin of claim 1, wherein a locking force of the locking brake can be set such that the swing door is securely held in any position between the closed position and the open position and including the closed position and the open position, and the locking brake is further configured to permit emergency opening.

5. The cabin of claim 1, wherein the swing door is movable between the closed position and the open position manually.

6. The cabin of claim 1, wherein the upper door mechanism comprises a single upper guide lever fastened via a first upper guide joint to the swing door, and is fastened via a second upper guide joint to the cabin.

7. The cabin of claim 1, wherein the lower door mechanism comprises a first support lever and a second support lever, the first support lever is fastened to the swing door via a first lower support joint and is fastened to the cabin via a third lower support joint, and the second support lever is fastened to the swing door via a second lower support joint and is fastened to the cabin via a fourth lower support joint.

8. The cabin of claim 7, wherein the lower door mechanism comprises a gas spring configured to dampen movement of the swing door between the closed position and the open position.

9. The cabin of claim 8, wherein the gas spring is arranged in an articulated manner between the first support lever or the second support lever and a floor of the cabin.

10. The cabin of claim 9, wherein a supporting tube is arranged between the first lower support joint and a first upper support joint.

11. The cabin of claim 7, wherein the lower door mechanism comprises a damper configured to dampen movement of the swing door proximate the open position.

12. The cabin of claim 1, wherein the cabin can be inclined relative to the vehicle crane about a horizontal pivot axis.

13. The cabin of claim 2, wherein the locking brake comprises a brake disc and brake shoes and can be actuated electrically, and wherein a locking force of the locking brake can be set such that the swing door is securely held in any position between the closed position and the open position and including the closed position and the open position, and the locking brake is further configured to permit emergency opening.

14. The cabin of claim 13, wherein the swing door is manually movable between the closed position and the open position.

15. The cabin of claim 14, wherein the upper door mechanism comprises a single upper guide lever fastened via a first upper guide joint to the swing door, and is fastened via a second upper guide joint to the cabin.

16. The cabin of claim 15, wherein the lower door mechanism comprises a first support lever and a second support lever, the first support lever is fastened to the swing door via a first lower support joint and is fastened to the cabin via a third lower support joint, and the second support lever is fastened to the swing door via a second lower support joint and is fastened to the cabin via a fourth lower support joint.

17. The cabin of claim 7, wherein a supporting tube is arranged between the first lower support joint and a first upper support joint.

18. The cabin of claim 17, wherein the lower door mechanism comprises a damper configured to dampen movement of the swing door proximate the open position.

19. The cabin of claim 18, wherein the cabin can be inclined relative to the vehicle crane about a horizontal pivot axis.

20. The cabin of claim 18, wherein the lower door mechanism comprises a gas spring configured to dampen movement of the swing door between the closed position and the open position, wherein the gas spring is arranged in an articulated manner between the first support lever or the second support lever and a floor of the cabin.
